(19) United States
(12) Patent Application Publication
(10) Pub. No.: US 2016/0316971 A1
(43) Pub. Date: Nov. 3, 2016

(54) Blending Appliance with Whisk Agitator

(71) Applicant: Sunbeam Products, Inc., Boca Raton, FL (US)

(72) Inventors: Moises Behar, Boca Raton, FL (US); Joseph C. Spencer, JR., Purvis, MS (US)

(73) Assignee: Sunbeam Products, Inc., Boca Raton, FL (US)

(21) Appl. No.: 15/144,473

(22) Filed: May 2, 2016

Related U.S. Application Data
(60) Provisional application No. 62/155,873, filed on May 1, 2015.

(51) Int. Cl. A47J 43/07; A47J 43/046

(52) U.S. Cl. CPC A47J 43/0722; A47J 43/046

(57) ABSTRACT

A blending appliance is provided including a motorized base, a blending container, and an agitator configuration fitted into an opening of the blending container and rotatably coupled to the motorized base when the blending container is mounted on the motorized base. The agitator configuration includes a blade arrangement disposed on a spindle performing a blending operation on ingredients at a lower end of the blending container and a whisk including a plurality of loops disposed a pre-determined distance from the blade arrangement at a distal end of a rotating shaft interconnected to the spindle.

### CROSS-REFERENCE TO RELATED APPLICATION

The present application claims benefit of U.S. Provisional Patent Application No. 62/155,873 filed May 1, 2015, entitled “Blender Static Whipper Agitator”.

### FIELD OF THE INVENTION

The invention relates to food preparation devices. More particularly, the invention relates to a blending or food processing appliance with an improved agitator configuration having both conventional blending blades and a blending implement to resist cavitation in the upper areas of the blending container.

### BACKGROUND OF THE INVENTION

Blending appliances used to blend beverages from solid and liquid ingredients are known. These blending appliances typically use agitators disposed in proximity to the bottom of the blending jar and formed from blade sets that perform different functions. Known problems include cavitation and solidification of blending ingredients in areas of the blending jar remote from the agitator configuration at the bottom of the blending jar.

### SUMMARY OF THE INVENTION

In an embodiment, there is provided a blending appliance including a motorized base, a blending container, and an agitator configuration fitted into an opening of the blending container and rotatably coupled to the motorized base when the blending container is mounted on the motorized base. The agitator configuration includes a blade arrangement disposed on a spindle performing a blending operation on ingredients at a lower end of the blending container, and a whisk including a plurality of loops disposed a pre-determined distance from the blade arrangement at a distal end of a rotating shaft interconnected to the spindle.

In an embodiment, there is provided an agitator configuration including a blade arrangement disposed on a spindle performing a blending operation on ingredients at a lower end of a blending container, and a whisk including a plurality of loops disposed a pre-determined distance from the blade arrangement at a distal end of a rotating shaft interconnected to the spindle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a blending appliance with a blending jar with an improved agitator configuration;

FIG. 2 is a partially exploded perspective view of the blending jar with the improved agitator configuration of FIG. 1;

FIG. 3 is an exploded perspective view of the improved agitator configuration of FIG. 2;

FIG. 4 is a top view of the improved agitator configuration of FIG. 2; and

FIG. 5 is a bottom view of the improved agitator configuration of FIG. 2.

### DETAILED DESCRIPTION OF THE INVENTION

While the present invention may be susceptible to embodiment in different forms, there are shown in the drawings, and herein will be described in detail, embodiments with the understanding that the present description is to be considered an exemplification of the principles of the invention and is not intended to limit the invention to that as illustrated and described herein. Instead, it is envisioned that those skilled in the art may devise various modifications and equivalents without departing from the spirit and scope of the appended claims.

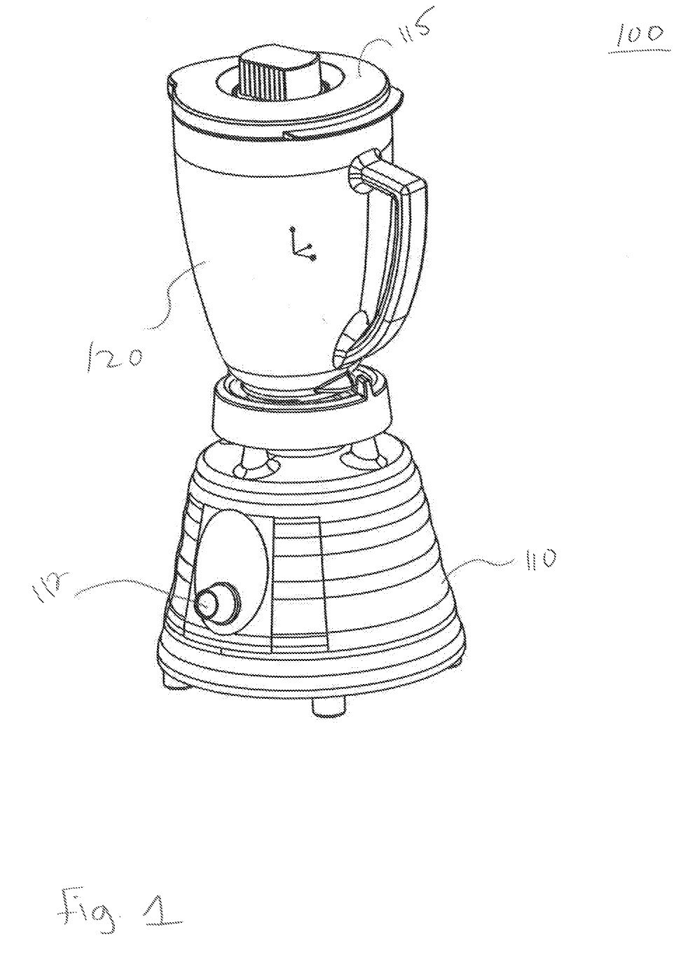

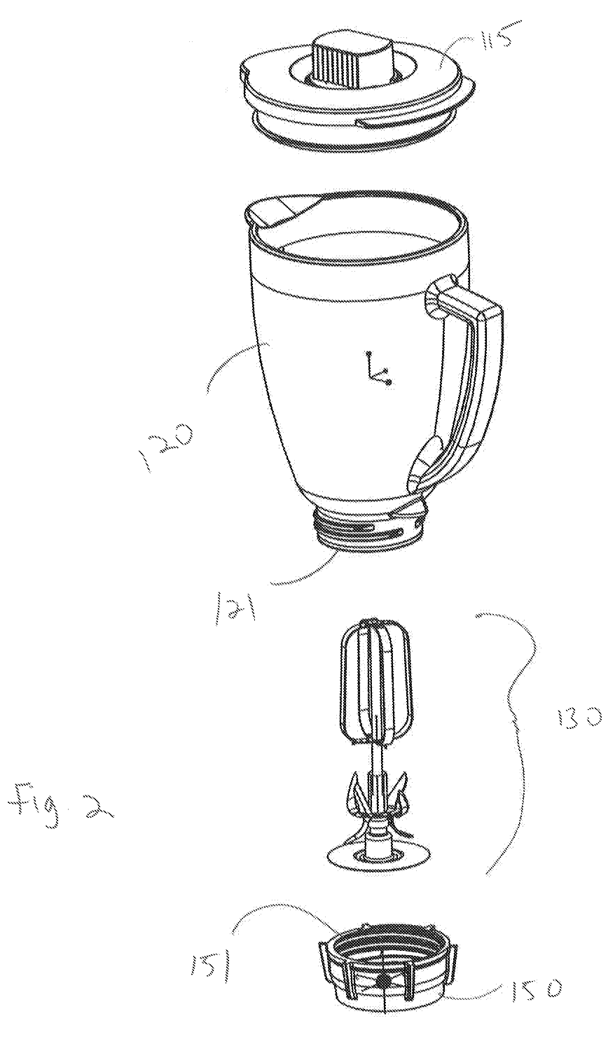

Referring now to FIGS. 1 and 2 of the drawings, in an embodiment there is illustrated a blending or food processing appliance 100. The Mending appliance 100 includes a motorized base 110 and a blending jar 120. In use, the blending jar 120 fits into a recess (not shown) formed in the base 110. The blending jar 120 includes a removable lid 115 that fits into an open top of the blending jar 120. The base 110 includes an electrical motor (not shown) for providing rotary power to an agitator configuration 130 disposed within the blending jar 120. Electronic controls 112 in the base 110 control electrical power to the electrical motor (not shown) which in an embodiment may include one or more switches for controlling the electrical motor (not shown) at various speeds including “off”, “low”, “medium” and “high”. In an alternate embodiment, the electronic controls may include a microprocessor (not shown) with memory storing pre-programmed routines for controlling the electrical motor (not shown).

The agitator configuration 130 is inserted into an opening (not shown) on the bottom end of the blending jar 120 and secured therein with an agitator nut 150 having internal threads 151 that engage complementary threads 121 around the opening (not shown) on the bottom end of the blending container 120.

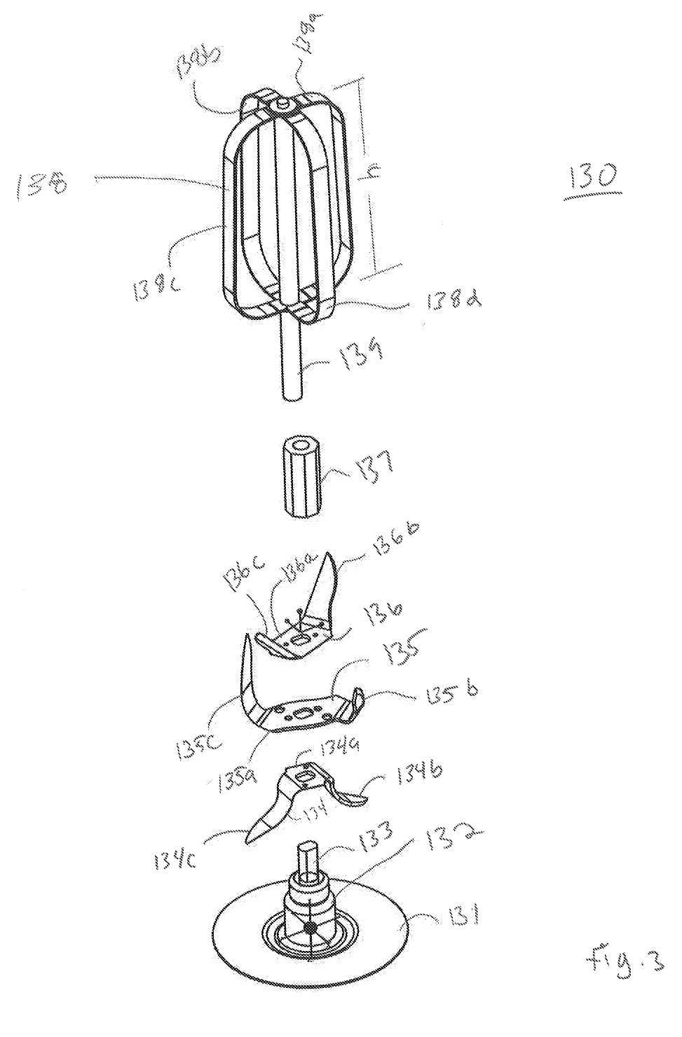

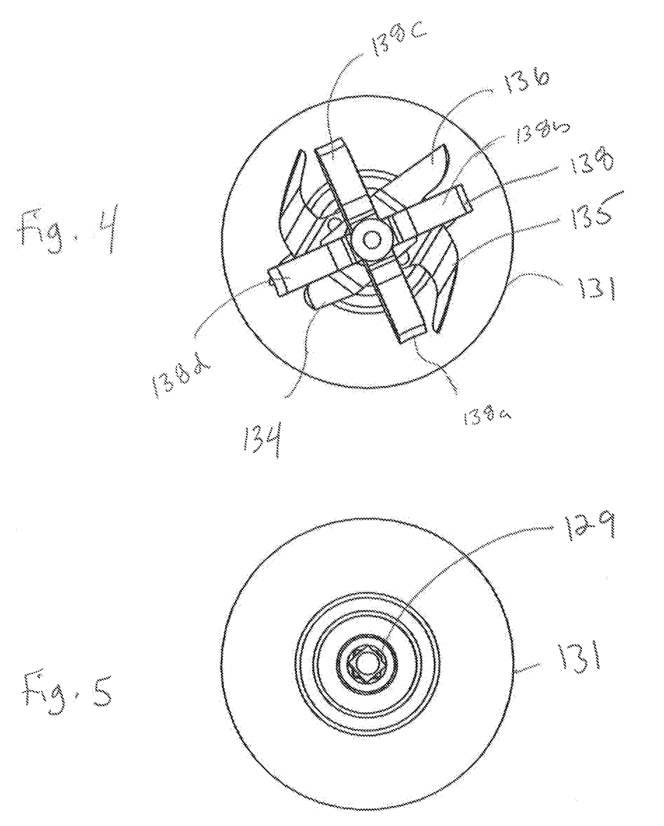

Referring now to FIGS. 3 to 5, the agitator configuration 130 includes a base 131 having a hub 132 containing a bearing assembly (not shown.) with a centrally disposed spindle 133 that passes therethrough. The spindle 133 is connected to a splined socket 129 disposed at the center of the bottom of the base 131. The socket 129 receives a complementary splined shaft (not shown) disposed in the recess (not shown) disposed in the base 110. The splined shaft (not shown) in the recess (not shown) transfers rotary power from the electrical motor (not shown) in the base 110 when the blending jar 120 is mounted on the base 110 and the electronic controls 112 are energized.

In the illustrated embodiment, the agitator configuration 130 includes a blade stack 136, 135, 134 mounted on the spindle 133 and secured thereon with an elongated threaded nut 137. The blade stack 136, 135, 134 is designed to allow for traditional blending functions while simultaneously providing improved food processing capabilities without the need to remove, change or alter the blade assembly within the blending appliance 100. The blade stack includes a top or first blade form 136, a middle or second blade form 135, and a third or bottom blade form 134. The blade forms 136, 135 and 134 may be made of any durable material such as metal, steel, carbon, composites, or any combinations of such material which can be sharpened and withstand the high stresses and heats generated in this environment.

The top blade form 136 and the bottom blade form 134 are preferably similar to a conventional blender blade design (one or more generally U-shaped blades). In particular, the top blade form 136 includes a central, substantially flat base 136a that extends radially with respect to the rotational axis R-R of the blade assembly. A first wing portion 136b extends at a. first angle upward from the base 136a and a second wing portion 136c extends at a second angle upward from an opposing end of the base 136a. While it is preferred that first and second wing portions respective 136b, 136c angles are not equal so as to provide enhanced blending and processing, it should be noted that such angles may be identical.

As with the top blade form 136, the bottom blade form 134 includes a central, substantially fiat base 134a extending radially with respect to the rotational axis RR of the agitator configuration 130. First 134b and second 134c curved blades are preferably formed integrally with the base 134a, and extend downward and outward from opposing ends of the base 134a. The curved shape of the blades 134b and 134c enhances blending and processing, and permits the edges of the blades 134b and 134c to extend to adjacent the agitator configuration base 131. In this manner, blended and processed items are dislodged and forced upward from the bottom of the jar 120.

The middle blade form 135 is an altered food processing blade design suited. for use in blending container having a smaller throat. Wherein a typical blending or food processor blade arrangement may include one or more generally flat blades extending radially outward from a central point of rotation, the middle blade form 135, in accordance with a preferred embodiment, is an S-shaped blade bent at opposing ends to a generally U-shaped configuration. The middle blade form 135 cooperates with the top and bottom blade forms 136 and 134 to enhance the circulation of blended or processed items while avoiding interference with the performance of the other blades.

Middle blade form 135 has a central, substantially flat base 135a extending radially from the axis of rotation RR of the agitator configuration 130. The central base 136a, 135a, and 134a of each of the top, middle and bottom blade forms 136, 135, and 134 are circumferentially offset from each other by a predefined angle as will be discussed in greater detail below. A first wing portion 135b extends upward and curves circumferentially away from the middle blade form's central base 135a. Similarly, from an opposing end of the central base 135a, a second wing portion 135e extends upward and curves circumferentially away from the central base 135a. The resultant compound curve of the first and second wing portions 135b and 135c of the middle blade form 135 allow for a longer blade length for improved food blending and processing capabilities.

The longer blade lengths allowed by the compound curve shape of the middle blade form 135 provides a continuous-radius edge along the entirety of each of the wing portions 135b and 135c so as to improve food processing performance of the agitator configuration 130 similar to that of the typical flat blades found in food processors. A knife-sharpened edge additionally enhances the middle blade form's 135 performance. Still further, the gull wing shape of the middle blade form 135 allows for its use, for example, in a smaller throat blender/processor jar 120 without negatively effecting the circulation of the blended/processed items during its operation. In part, the gull wing shape of the middle blade form 135 achieves this balance of improved performance and reduced circulatory impact by remaining an optimal distance from the throat wall of the blender/processor jar 120. The gull-wing shape allows for a balancing of being far enough away from the jar 120 wall so as not to merely force items down into the bottom blade form 134 and thus liquefy them, while not placing the blade tips so far from the throat wall so as to fail to pull the processed items into the agitator configuration 130 for processing. As a result, the enhanced performance of the blade stack, and the agitator configuration 130 as a whole, are directly related to the defined angles involved in shaping the middle blade form 135.

The enhanced processing performance is also a direct result of the middle blade form's 135 orientation to the top and bottom blade forms 136 and 134 as best seen in FIG. 3. More specifically, it is preferred that the wing portions 135b and 135c of the middle blade form 135 make generally about a seventy-five degree angle with the horizontal plane (i.e., generally about a one-hundred five degree vertical angle between the wing portions 135b and 135c and the central base 135a of the middle blade form 135). Further, the point of intersection. of the wing portions 135b and 135c and the central base 135a of the middle blade form 135, the bend line, makes an angle generally about thirty four and one-half degrees with the center line of the S-shaped middle blade form's central base 135a, These precise angles provide for improved interaction between the middle blade form 135, the jar wall, and the processed items (not shown).

With regard to the interaction of the top, bottom and middle blade forms 136, 135 and 134, FIG. 3 best shows their respective orientation to one another. The blade tips of the blending blades, the top and bottom blade forms 136 and 134, are offset by an angle generally about twenty seven and one-half degrees and the angle formed between the tips of the middle and bottom blade forms 135 and 134 is generally about seventy seven degrees. It is these angles of rotation and the various angles of lift on the individual wing portions of the various blade forms that directly drive the performance of the agitator configuration by reducing interference by one blade form with another while enhancing the ability to circulate the blended/processed items and reducing the wear-and-tear on the assembly's bearings and the blender/processor motor (not shown).

In other embodiments, any one of the aforementioned top, middle and bottom blade forms 136, 135, 134 may be omitted or used in any combination with each other or in any combination with any other known or unknown blade forms.

In an embodiment, a whisk 138 comprised of a plurality of loops 138a-d comprised of fiat blades or wire are disposed on one end of a central rotary shaft 139. The rotary shaft 139 is connected by the threaded nut 137 to the spindle 133. The whisk 138 extends into the upper areas of the blending jar 120 when the agitator configuration 130 is installed in blending jar 120. The whisk 138 is disposed a pre-determined distance D above the blade stack comprised of the top, middle and lower blade forms 136, 135 and 134. The whisk 138 when rotated prevents cavitation and solidification of the blended contents above the lower positioned blade stack comprised of the top, middle and lower blade forms 136, 135 and 134. The height h of the plurality of loops 138a-d and the pre-determined distance D are optimized based on the size of the blending jar 120 and may vary as the height and width of the blending jar 120 is varied. This optimization provides for optimal interaction of the moving blended contents with the interior walls of the blending jar 120 to prevent cavitation and solidification of the blended contents above the blade stack comprised of the top, middle and lower blade forms 136, 135 and 134 below.

In another embodiment, the foregoing whisk 138 may be used with in combination with any other known or unknown blade forms disposed on the spindle 133 at the bottom of the blending jar 120.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A blending appliance, comprising:
a motorized base;
a blending container; and
an agitator configuration fitted into an opening of the blending container and rotatably coupled to the motorized base when the blending container is mounted on the motorized base, the agitator configuration including:
a blade arrangement disposed on a spindle performing a blending operation on ingredients at a lower end of the blending container; and
a whisk including a plurality of loops disposed a pre-determined distance from the blade arrangement at a distal end of a rotating shaft interconnected to the spindle.

2. The blending appliance of claim 1, wherein the blade arrangement includes a top blade form including opposing wing portions angled upward.

3. The blending appliance of claim 1, wherein the blade arrangement includes a middle blade form including opposing wing portions angled upward and curved.

4. The blending appliance of claim 1, wherein the blade arrangement includes a bottom blade form including opposing wing portions angled downward.

5. The blending appliance of claim 1, wherein the plurality of loops are formed from flat strips.

6. The blending appliance of claim 1, wherein the plurality of loops are formed from wire.

7. An agitator configuration, comprising:
a blade arrangement disposed on a spindle performing a blending operation on ingredients at a lower end of a blending container; and
a whisk including a plurality of loops disposed a pre-determined distance from the blade arrangement at a distal end of a rotating shaft interconnected to the spindle.

8. The agitator configuration of claim 7, wherein the blade arrangement includes a top blade form including opposing wing portions angled upward.

9. The agitator configuration of claim 7, wherein the blade arrangement includes a middle blade form including opposing wing portions angled upward and curved.

10. The agitator configuration of claim 7, wherein the blade arrangement includes a bottom blade form including opposing wing portions angled downward.

11. The agitator configuration of claim 7, wherein the plurality of loops are formed from flat strips.

12. The agitator configuration of claim 7, wherein the plurality of loops are formed from wire.
